(19) United States
(12) Patent Application Publication
(10) Pub. No.: US 2025/0127101 A1
(43) Pub. Date: Apr. 24, 2025

(54) WALK-BEHIND BLOWER

(71) Applicant: Milwaukee Electric Tool Corporation, Brookfield, WI (US)

(72) Inventors: Michael Steven Van Dyke, Wauwatosa, WI (US); Kyle Reeder, Brookfield, WI (US); Joseph S. Wilinski, JR., Brookfield, WI (US); Austin De Veer, Brookfield, WI (US); Adam E. Czerwonka, Mukwanago, WI (US); Seamus Joseph Doyle Herson, Wauwatosa, WI (US)

(21) Appl. No.: 18/910,208

(22) Filed: Oct. 9, 2024

Related U.S. Application Data
(60) Provisional application No. 63/591,854, filed on Oct. 20, 2023.

(51) Int. Cl. A01G 20/47

(52) U.S. Cl. CPC A01G 20/47

(57) ABSTRACT

A walk-behind blower includes a frame; one or more movable elements mounted to the frame to movably support the frame; a housing supported on the frame, the housing defining an airflow conduit extending therethrough between a first end and a second end; and a fan assembly disposed between the first end and the second end, the fan assembly comprising a blower fan having a plurality of fan blades, and a motor rotatably connected to the blower fan.

### CROSS REFERENCE TO RELATED APPLICATIONS

The present application claims priority to U.S. Provisional Patent Application No. 63/591,854 filed on Oct. 20, 2023, the disclosure of which is incorporated by reference herein in its entirety.

### FIELD

The present disclosure relates generally to outdoor power equipment, and more particularly to improved debris collection tools, such as for collection of leaves and other outdoor debris.

### BACKGROUND

Improved performance, durability, and/or longevity in outdoor power equipment, especially in debris collection tools, is desired. For instance, blower tools have long been used to move large volumes of debris, particularly leaves, in order to clear property. This may require significant amounts of force to propel the leaves. In the case of hand-held or backpack blower tools, it may be difficult to provide a tool capable of reaching suitable power levels, particularly one that is not unwieldy, cumbersome, or expensive for many users. Some walk-behind blower tools exist to help mitigate such problems. Existing tools typically rely on an internal combustion engine, which may power rotation of a centrifugal fan. Often, such tools are still noisy, inefficient, or difficult to maneuver.

Accordingly, improvements which address the above-described issues are desired in the art and would be advantageous. For instance, it may be advantageous to provide walk-behind blower able to deliver significant blower force (e.g., in a relatively compact profile). Additionally or alternatively, an easily maneuverable walk-behind blower may be useful. Still additionally or alternatively, it may be advantageous to provide a relatively quiet walk-behind blower.

### BRIEF DESCRIPTION

Aspects and advantages of the present disclosure will be set forth in part in the following description, or may be obvious from the description, or may be learned through practice of the technology.

In accordance with one embodiment, a walk-behind blower is provided. The walk-behind blower may include a frame, one or more walking elements, a housing, and a fan assembly. The one or more walking elements may be mounted to the frame to movably support the frame. The housing may be supported on the frame. The housing may define an airflow conduit extending therethrough between a first end and a second end. The fan assembly may be disposed between the first end and the second end. The fan assembly may include an axial fan having a plurality of fan blades and a motor rotatably connected to the axial fan.

In accordance with another embodiment, a walk-behind blower is provided. The walk-behind blower may include a frame, one or more walking elements, a battery compartment, a housing, and a fan assembly. The one or more walking elements may be mounted to the frame to movably support the frame. The battery compartment may be attached to the frame to receive a battery pack. The housing may define an airflow conduit extending therethrough between a first end and a second end. The fan assembly may be disposed between the first end and the second end. The fan assembly may include a blower fan having a plurality of fan blades and a motor rotatably connected to the blower fan. The motor may be in electrical communication with the battery pack to motivate rotation of the blower fan.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 provides a perspective view of a walk-behind blower in accordance with embodiments of the present disclosure;

FIG. 2 provides a perspective view of a fan assembly of the exemplary walk-behind blower of FIG. 1; and

FIG. 3 provides a perspective view of the exemplary fan assembly of FIG. 2, wherein a cross-sectional portion of the fan assembly has been removed for clarity.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present). A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure provides a user-friendly walk-behind blower. Such a blower may include a fan assembly having an axial fan advantageously capable of significant blower force (e.g., in a relatively compact or quiet package, in comparison to existing blowers). Notably, the fan assembly may be battery powered and relatively quiet during use.

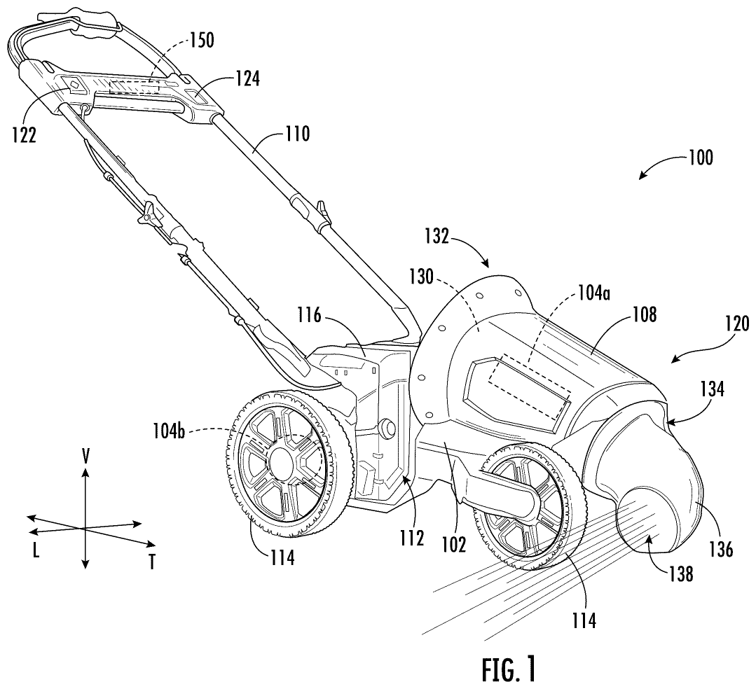

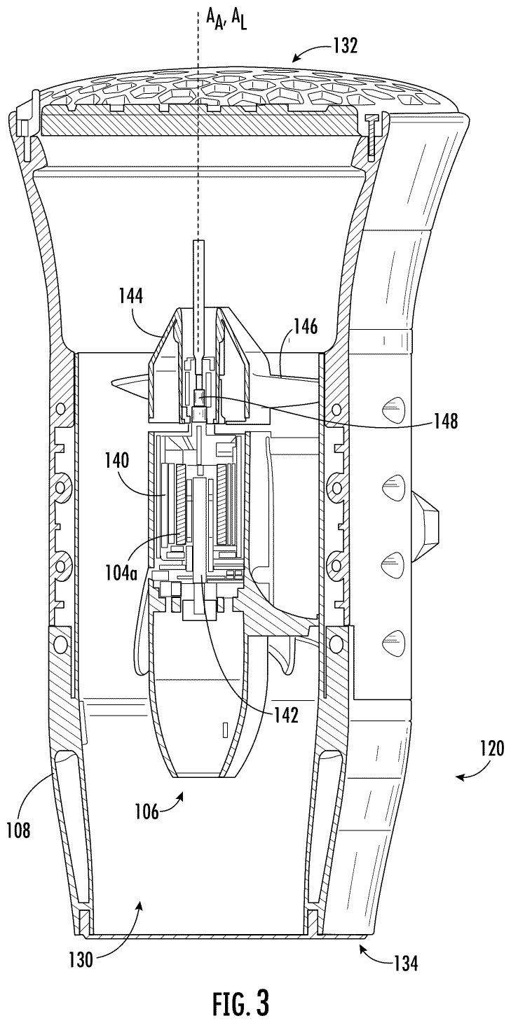

Referring now to the drawings, FIG. 1 illustrates a perspective view of a walk-behind blower 100 in accordance with various exemplary embodiments of the present disclosure. Generally, walk-behind blower 100 defines a mutually orthogonal vertical direction V, lateral direction L, and transverse direction T. The walk-behind blower 100 includes a frame 102, one or more motors 104 (e.g., fan motor 104a or wheel motor 104b), and a fan assembly 120. The fan assembly 120 may include an axial or blower fan 106 (FIG. 3) may be coupled or attached (e.g., rotatably mounted) to the frame 102 (e.g., disposed in fan housing 108) to rotate about a defined motor axis A_{A}.

As shown, the fan housing 108 may be supported on (e.g., mounted to) the frame 102 and defines an airflow conduit 130 that extends (e.g., along a longitudinal axis A_{L}) between a first end 132 (e.g., air inlet end) and a second end 134 (e.g., air outlet end). An axial length is defined from the first end 132 to the second end 134. In some embodiments, the axial length may be between 10 inches and 20 inches (e.g., between 12 inches and 16 inches). In optional embodiments, the first end 132 is disposed higher (e.g., at a greater distance relative to the ground) than the second end 134 relative to the vertical direction V.

The walk-behind blower 100 is generally configured to generate airflow along the airflow conduit 130 extending between the first end 132, e.g., air inlet, and the second end 134, e.g., air outlet, of the walk-behind blower 100. The airflow conduit 130 may include a tube as shown.

Turning now generally to FIGS. 1 through 3, FIGS. 2 and 3 provide a perspective view of a fan assembly 120 of the walk-behind blower 100 according to exemplary embodiments. As illustrated, a housing 108, e.g., a main body of the walk-behind blower 100, may at least partially enclose components of the walk-behind blower 100 such as an airflow generation assembly 120 including a fan 106 and a motor 104a that drives the fan 106, as well as various other components. For instance, airflow generation assembly 120 may be disposed between the first end 132 and the second end 134 of the airflow conduit 130.

As shown, an elbow nozzle 136 may be attached to the housing. In particular, the elbow nozzle 136 may be attached on the second end 134 in downstream fluid communication with the airflow conduit 130. Thus, the elbow nozzle 136 may be downstream from the second end 134 to direct airflow therefrom. In some embodiments, the elbow nozzle 136 defines an elbow outlet 138 non-parallel to the second end 134. The angle of the elbow outlet 138 relative to the second end 134 (or longitudinal axis A_{L} of the airflow conduit 130) may be greater than 0° and less than 180° (e.g., around) 90°. Optionally, the angle of the elbow outlet 138 relative to the second end 134 may be fixed. In additional or alternative embodiments, the elbow outlet 138 is defined at a negative angle relative to a horizontal direction (e.g., lateral direction L or transverse direction T), such as between 1° and 30°. Optionally, the elbow nozzle 136 may be rotatably mounted to the housing. Thus, the angle of the elbow outlet 138 relative to the horizontal direction may be variable. For instance, the elbow nozzle 136 may be rotatably mounted to the housing to rotate about the longitudinal axis A_{L} of the airflow conduit 130. In additional or alternative embodiments, the airflow from the housing 108 or nozzle 136 may be selectively redirected (e.g., via rotation of nozzle) by a discrete remote control input (e.g., in mechanical or electrical communication with an assembly to rotate the nozzle 136), which may be mounted to a handle assembly 110.

Walk-behind blower 100 may further include a handle assembly 110 extending from the frame 102. As illustrated, the handle assembly 110 can extend from a rear end of the frame 102 in a generally vertical direction V. The handle assembly 110 may include one or more controls associated with controlling operational aspect(s) of the walk-behind blower 100. By way of non-limiting example, the handle assembly 110 can include a power button 122 and one or more speed inputs (e.g., speed input 124) operably coupled to a controller 150. A battery compartment 112 can be attached to the frame 102 (e.g., apart or rearward from the first end 132) to receive one or more batteries or battery packs 116, which can provide power to the one or more motors 104a, 104b (e.g., one more electric motors). Thus, one or more of the motors 104a, 104b may be in electrical communication with the battery pack 116 to receive an electrical current therefrom, such as to motivate rotation of the fan 106 or walking elements 114.

The frame 102, or walk-behind blower 100 generally, is supported by one or more walking elements 114 (e.g., wheels or continuous track treads). In some embodiments, the walking elements 114 include one or more forward walking elements 114 and one or more rear walking elements 114. In certain embodiments, one or more walking elements 114 (e.g., rear walking elements 114) define a wheel axis (e.g., parallel to the lateral direction L) about which the elements or wheels 114 rotate. The rear walking element(s) 114 may be disposed rearward from the first end 132. Additionally or alternatively, the front walking elements 114 may be disposed (e.g., partially or fully) forward from the first end 132 and, optionally, rearward from the second end 134 (e.g., at the wheel axis of the front walking element(s) 114). Further additionally or alternatively, the walking element(s) 114 may be disposed (e.g., partially or fully) rearward from the nozzle 136.

In optional embodiments, the wheels 114 include a pair of driven wheels that can be driven or rotated by a discrete wheel motor 104b (e.g., separate from fan motor 104a). As illustrated, the wheel motor 104b may be supported on the frame 102 apart from the fan motor 104a. Although the driven wheels 114 may be motivated or rotated by wheel motor 104b, an operator or user may selectively push the walk-behind blower 100 (e.g., manually).

In some embodiments, a controller 150 may be provided in operative communication with one or more components of walk-behind blower 100 (e.g., motors 104a, 104b, etc.). The controller 150 may include a memory and one or more microprocessors, CPUs or the like, such as general or special purpose microprocessors operable to execute programming instructions or micro-control code associated with operation of walk-behind blower 100. The memory may represent random access memory such as DRAM, or read only memory such as ROM or FLASH. In some embodiments, the processor executes non-transitory programming instructions stored in memory. For certain embodiments, the instructions include a software package configured to operate walk-behind blower 100 or execute an operation routine. The memory may be a separate component from the processor or may be included onboard within the processor. Alternatively, controller 150 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

In some embodiments, controller 150 is particularly configured (e.g., programmed) to direct rotation of the fan motor 104a at a set or selected velocity. Optionally, controller 150 may be configured to direct a progressive fan velocity. The progressive fan velocity may gradually increase a target rotational velocity at the fan motor 104a (e.g., from a static state). Thus, the progressive fan velocity may determine the fan motor 104a is at a static (e.g., stopped or unpowered) state such that airflow is not being motivated at the blower fan 106. Subsequently, the controller 150 may receive an activation signal (e.g., from the power button 122, speed input 124, or one or more other controls) and determine a operational target speed for the fan motor 104a. The controller 150 may then set one or more intermediate target speeds between 0 and the operational target speed. In turn, the fan motor 104a may be progressively directed to the one or more intermediate target speeds (e.g., according to a predetermined pattern or interval), increasing the target speed until the operational target speed is met. Upon being met, the motor 104a may continue at the operational target speed (e.g., indefinitely, such as until battery power is fully dissipated, a halt-rotation signal is received, or a user otherwise directs the fan assembly 120 to stop). Notably, a soft-start velocity ramping of the fan assembly 120 may be achieved.

Controller 150 may be positioned in a variety of locations throughout walk-behind blower 100. Input/output (“I/O”) signals may be routed between controller 150 and various operational components of walk-behind blower 100. One or more components of walk-behind blower 100 may be in operative communication (e.g., electric communication) with controller 150 via one or more conductive signal lines or shared communication busses.

Optionally, the walk-behind blower 100 can include one or more lighting elements (e.g., one or more light emitting diodes, commonly referred to as LEDs) configured to illuminate one or more areas of the environment in which the walk-behind blower 100 is operating. For example, the walk-behind blower 100 can include one or more lights (e.g., including one or more light emitting diodes, fluorescent bulbs, halogen bulbs, incandescent bulbs, etc.) disposed on the fan housing 108. The light can be disposed on a front portion of the fan housing 108 so as to illuminate an area in front of the walk-behind blower 100 during operation (e.g., an area or debris to be treated with the walk-behind blower 100). Additionally or alternatively, the walk-behind blower 100 can include one or more light or light units (e.g., including one or more light emitting diodes, fluorescent bulbs, halogen bulbs, incandescent bulbs, etc.) configured to illuminate a path cleared by the walk-behind blower 100. For instance, the light unit(s) can be mounted on the handle assembly 110 or any other suitable location to illuminate in a direction rearward from a path cleared by the fan assembly 120.

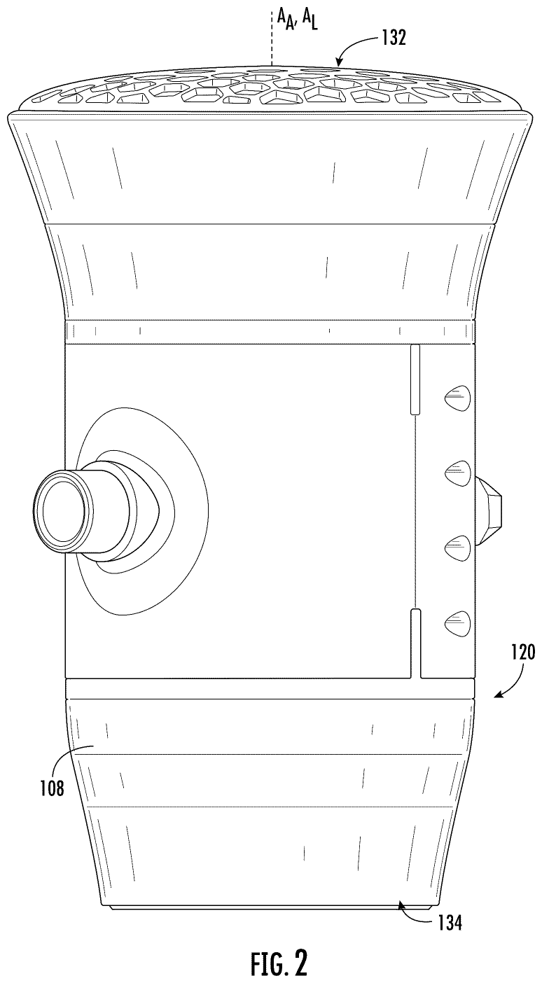

Referring especially to FIGS. 2 and 3, the fan assembly 120 may have an axial configuration including an axial fan 106. The motor 104a may be mounted within the housing 108. For instance, the housing 108 may include a motor mount 140 configured to support the motor 104a between the first end 132 and the second end 134. The motor 104a is oriented along a motor axis A_{A}. In some embodiments, the motor axis A_{A} coincides with a longitudinal axis A_{L} of the airflow conduit 130. Rotation of the motor 104a causes rotation of a primary motor shaft 142 extending along the motor axis A_{A}. The motor shaft 142 is coupled to the fan 106 (e.g., rotatably connected to the fan 106). In this manner, rotation of the motor shaft 142 causes rotation of the fan 106. The motor 104a may be configured to operate at a rotational speed in a range from about 21000 rotations per minute (RPM) to about 38000 RPM.

In some embodiments, fan 106 includes a hub 144 and a plurality of blades 146. The hub 144 may have a generally circular cross-sectional shape and may extend along the motor axis A_{A}. The motor shaft 142 is coupled to the hub 144 or a fan drive shaft 148 to enable transmission of rotation from the motor 104a to the hub 144 or the fan drive shaft 148 and ultimately to the blades 146.

Generally, each respective fan blade 146 extends radially away from the hub 144. Each blade 146 extends from a root and terminates at a tip end, and has a first face and a second face opposite the first face. The root contacts the hub 144 of the fan 106.

The present inventors have found that the fan assembly 120 of the present invention having an axial fan 106 may be optimized when a dimensionless flow coefficient Φ is in a range from about 0.2 to about 0.6. The size and speed of the fan assembly 120 are defined as a function of the optimal flow coefficient Φ. The flow coefficient is calculated by the following equation:

$$Φ = \frac{q / ( A )}{ω R}$$

where q represents flow (m³/s), A represents cross sectional area at the fan (m²), ω represents speed (rad/s) and R represents fan tip radius (m) measured at a blade tip. Stated differently, the numerator q/(A) is the axial velocity of the fan (meters per second).

Based on the calculation of the flow coefficient Φ as shown above, the optimal size of the fan may be determined by rearranging the equation as shown below:

$$R = \frac{q / ( A )}{ω {Φ}_{ideal}}$$

By optimizing both the blade solidity and the flow coefficient of the fan assembly 120 during operation of the walk-behind blower 100, the present inventors have found that the walk-behind blower 100 may generate less audible noise while maintaining optimal airflow characteristics, thereby improving the user's overall experience during operation of the walk-behind blower 100. For instance, reducing the audible noise generated by the walk-behind blower 100 may be highly desirable to users, particularly for homeowners and other non-professional users. Simultaneously, maintaining optimal airflow characteristics may enable efficient battery life of the walk-behind blower 100, reducing the need for users to recharge or replace the power source without reducing the power of the airflow generated during operation. Additionally or alternatively, blower 100 may have significantly higher air flow than known blowers.

Further aspects of the disclosure are provided by one or more of the following embodiments:

A walk-behind blower may include a frame; one or more movable elements mounted to the frame to movably support the frame; a housing supported on the frame, the housing defining an airflow conduit extending therethrough between a first end and a second end; and a fan assembly disposed between the first end and the second end, the fan assembly comprising an axial fan having a plurality of fan blades, and a motor rotatably connected to the axial fan.

The walk-behind blower of any one or more of the embodiments, further includes an elbow nozzle attached to the housing on the second end in downstream fluid communication with the airflow conduit.

The walk-behind blower of any one or more of the embodiments, wherein the elbow nozzle is rotatably mounted to the housing to rotate about a longitudinal axis of the airflow conduit.

The walk-behind blower of any one or more of the embodiments, further comprising a handle assembly attached to the frame and extending rearward relative to the housing, wherein the one or more movable elements are disposed rearward from the elbow nozzle.

The walk-behind blower of any one or more of the embodiments, further comprising a driving motor in mechanical communication with the one or more movable elements to propel the walk-behind blower apart from the fan assembly.

The walk-behind blower of any one or more of the embodiments, further comprising a controller in communication with the motor, the controller being configured to direct a progressive fan velocity to gradually increase a target rotational velocity at the motor from a static state.

The walk-behind blower of any one or more of the embodiments, wherein an axial length is defined from the first end to the second end, the axial length being between 10 inches and 20 inches.

The walk-behind blower of any one or more of the embodiments, further comprising a battery compartment attached to the frame rearward from the first end to receive a battery pack, wherein the motor is in electrical communication with the battery pack to motivate rotation of the axial fan.

The walk-behind blower of any one or more of the embodiments, wherein the one or more movable elements comprises a forward wheel rotatably mounted forward from first end and a rear wheel rotatably mounted rearward from first end.

The walk-behind blower of any one or more of the embodiments, wherein the first end is disposed higher than the second end relative to a vertical direction.

A walk-behind blower includes a frame; one or more movable elements mounted to the frame to movably support the frame; a battery compartment attached to the frame to receive a battery pack; a housing attached on the frame, the housing defining an airflow conduit extending therethrough between a first end and a second end; and a fan assembly disposed between the first end and the second end, the fan assembly comprising a blower fan having a plurality of fan blades, and a motor rotatably connected to the blower fan, the motor being in electrical communication with the battery pack to motivate rotation of the blower fan.

The walk-behind blower of any one or more of the embodiments, further comprising an elbow nozzle attached to the housing on the second end in downstream fluid communication with the airflow conduit.

The walk-behind blower of any one or more of the embodiments, wherein the elbow nozzle is rotatably mounted to the housing to rotate about a longitudinal axis of the airflow conduit.

The walk-behind blower of any one or more of the embodiments, further comprising a handle assembly attached to the frame and extending rearward relative to the housing, wherein the one or more movable elements are disposed rearward from the elbow nozzle.

The walk-behind blower of any one or more of the embodiments, further comprising a driving motor in mechanical communication with the one or more movable elements to propel the walk-behind blower apart from the fan assembly.

The walk-behind blower of any one or more of the embodiments, further comprising a controller in communication with the motor, the controller being configured to direct a progressive fan velocity to gradually increase a target rotational velocity at the motor from a static state.

The walk-behind blower of any one or more of the embodiments, wherein an axial length is defined from the first end to the second end, the axial length being between 10 inches and 20 inches.

The walk-behind blower of any one or more of the embodiments, wherein the first end defines an air intake upstream from the airflow conduit, and wherein the battery compartment is attached to the frame rearward from the first end.

The walk-behind blower of any one or more of the embodiments, wherein the one or more movable elements comprises a forward wheel rotatably mounted forward from first end and a rear wheel rotatably mounted rearward from first end.

The walk-behind blower of any one or more of the embodiments, wherein the first end is disposed higher than the second end relative to a vertical direction.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A walk-behind blower comprising:
a frame;
one or more movable elements mounted to the frame to movably support the frame;
a housing supported on the frame, the housing defining an airflow conduit extending therethrough between a first end and a second end; and
a fan assembly disposed between the first end and the second end, the fan assembly comprising an axial fan having a plurality of fan blades, and a motor rotatably connected to the axial fan.

2. The walk-behind blower of claim 1, further comprising an elbow nozzle attached to the housing on the second end in downstream fluid communication with the airflow conduit.

3. The walk-behind blower of claim 2, wherein the elbow nozzle is rotatably mounted to the housing to rotate about a motor axis of the airflow conduit.

4. The walk-behind blower of claim 2, further comprising a handle assembly attached to the frame and extending rearward relative to the housing, wherein the one or more movable elements are disposed rearward from the elbow nozzle.

5. The walk-behind blower of claim 1, further comprising a driving motor in mechanical communication with the one or more movable elements to propel the walk-behind blower apart from the fan assembly.

6. The walk-behind blower of claim 1, further comprising a controller in communication with the motor, the controller being configured to direct a progressive fan velocity to gradually increase a target rotational velocity at the motor from a static state.

7. The walk-behind blower of claim 1, wherein an axial length is defined from the first end to the second end, the axial length being between 10 inches and 20 inches.

8. The walk-behind blower of claim 1, further comprising a battery compartment attached to the frame rearward from the first end to receive a battery pack,
wherein the motor is in electrical communication with the battery pack to motivate rotation of the axial fan.

9. The walk-behind blower of claim 1, wherein the one or more movable elements comprises a forward wheel rotatably mounted forward from first end and a rear wheel rotatably mounted rearward from first end.

10. The walk-behind blower of claim 1, wherein the first end is disposed higher than the second end relative to a vertical direction.

11. A walk-behind blower comprising:
a frame;
one or more movable elements mounted to the frame to movably support the frame;
a battery compartment attached to the frame to receive a battery pack;
a housing attached on the frame, the housing defining an airflow conduit extending therethrough between a first end and a second end; and
a fan assembly disposed between the first end and the second end, the fan assembly comprising a blower fan having a plurality of fan blades, and a motor rotatably connected to the blower fan, the motor being in electrical communication with the battery pack to motivate rotation of the blower fan.

12. The walk-behind blower of claim 11, further comprising an elbow nozzle attached to the housing on the second end in downstream fluid communication with the airflow conduit.

13. The walk-behind blower of claim 12, wherein the elbow nozzle is rotatably mounted to the housing to rotate about a motor axis of the airflow conduit.

14. The walk-behind blower of claim 12, further comprising a handle assembly attached to the frame and extending rearward relative to the housing, wherein the one or more movable elements are disposed rearward from the elbow nozzle.

15. The walk-behind blower of claim 11, further comprising a driving motor in mechanical communication with the one or more movable elements to propel the walk-behind blower apart from the fan assembly.

16. The walk-behind blower of claim 11, further comprising a controller in communication with the motor, the controller being configured to direct a progressive fan velocity to gradually increase a target rotational velocity at the motor from a static state.

17. The walk-behind blower of claim 11, wherein an axial length is defined from the first end to the second end, the axial length being between 10 inches and 20 inches.

18. The walk-behind blower of claim 11, wherein the first end defines an air intake upstream from the airflow conduit, and
wherein the battery compartment is attached to the frame rearward from the first end.

19. The walk-behind blower of claim 11, wherein the one or more movable elements comprises a forward wheel rotatably mounted forward from first end and a rear wheel rotatably mounted rearward from first end.

20. The walk-behind blower of claim 11, wherein the first end is disposed higher than the second end relative to a vertical direction.
